(19) United States
(12) Patent Application Publication
(10) Pub. No.: US 2005/0004757 A1
(43) Pub. Date: Jan. 6, 2005

(54) Method and control, means for route planning in a mass transport system

(76) Inventors: Teddy T Neeman, Tel Aviv (IL); Doron Shalev, Alfei-Menahshe (IL)

Correspondence Address: MOTOROLA INC, 600 NORTH US HIGHWAY 45, ROOM AS437, LIBERTYVILLE, IL, 60048-5343, US

(21) Appl. No.: 10/486,167

(22) PCT Filed: Jul. 22, 2002
(86) PCT No.: PCT/EP02/08199

(30) Foreign Application Priority Data
Aug. 8, 2001 (GB) 0119286.3

(51) Int. Cl. G01C 21/30

(52) U.S. Cl. 701/210; 701/208

(57) ABSTRACT

The invention relates to a mass transport system and to a method of providing transportation. In the disclosed method and system, a route using mass transport resources is planned for a user in response to a request for transportation and the user is informed of the planned route. The system subsequently tracks the progress of the user along the planned route and optimizes the planned route in real-time. The invention enables the provision of transportation services using mass transport resources combining efficiency in the use of the mass transport resources and convenience for the user.

The present invention relates to a method of route planning in a mass transport system, a control means for a mass transport system, a personal device adapted for operation in a mass transport system and method therefor.

There is a need to transport people around an area, typically a town or a city. Currently, in general, the transportation needs are met by bus and/or tram networks, together with taxis. However, these systems all have disadvantages in providing a mass transportation system.

The existing transport networks tend to suffer from the disadvantage that a user experiences long and unknown waiting periods. Moreover, in general users do not have access to real time or near real time information about schedules and the location of vehicles.

In addition, in situations where it is necessary for the user to use two or more vehicles to complete the journey, the user may plan a sub-optimal route and combination of vehicles. If a change of vehicle is necessary for the planned route, the time required for connection between the two vehicles may be lengthy, or if only a short time between connections is allowed the connection might be missed because of the late arrival of the first vehicle. In addition, it may be impossible to connect between two vehicles which run at least partially over the same route because the buses do not stop at the same stop or at conveniently close stops.

The use of taxis or private cars overcomes some of these disadvantages, in that a door-to-door service is possible and the journey time is minimized. However, taxis are considerably more expensive than public transport; and private cars must be parked at the destination. In addition, both these solutions undesirably increase the congestion in towns and cities.

In summary, it can be seen that mass transport is theoretically efficient, because many people can be carried on the same vehicle, compared with the inherent inefficiency of taxis and private cars, that carry just a small payload, usually a single customer. The inefficiency of taxis and cars causes congestion in our cities and towns.

However, the theoretical efficiency of mass transportation is offset by lack of communication channels between carrier and customers, not allowing them to fully utilize the service. For example, the person waiting at a bus stop sees many buses passing by in his direction, but cannot board them because either they do not stop at that stop, or that he is not sure what connection will be available and where, and at what time. The person may have to wait in frustration quite a while for the bus that he had in mind, inflexible to the actual timing and positions of the buses or traffic conditions.

Thus there is a need for a method of route planning in a mass transport system which provides a better service to users.

In accordance with a first aspect of the invention there is provided a method of route planning, in a mass transport system for providing transportation from a respective location to a respective destination for each of a plurality of users using a plurality of mass transit resources traveling along predetermined routes, wherein each of the users has a user device, the method comprising: determining a planned route for a user from location to destination using at least one of the plurality of mass transit resources; providing the user with information relating to the planned route; and receiving information communicated from the user device of the user so as to automatically track the progress of the user along the planned route; and optimizing the planned route during progress of the user along the planned route.

In accordance with a second aspect of the invention there is provided a control means for a mass transport system for providing transportation from a respective location to a respective destination for each of a plurality of users, each having a user device, using a plurality of mass transit resources traveling along predetermined routes, comprising a route planner means for carrying out the method in accordance with the invention.

Thus the invention provides a route planning method and control means for a mass transport system comprising a route planner means which enables personalized service for each user. Since the plurality of mass transit resources of the transportation system travel along predetermined routes the transportation system provided by the invention is operationally efficient while increasing the convenience to passengers.

The invention enables the transportation system operator to plan a desirable route for each of a plurality of users, and then to track the progress of each of the plurality of users in real time using communications received from a user device of the user. These communications may be facilitated using different communications technologies, in particular using relatively long-range cellular communications systems and/or using relatively short-range communication systems such as Bluetooth™. This tracking occurs automatically, for example by means of the interaction of a Bluetooth™-enabled user device and a Bluetooth™ module on a vehicle and action of the user is not required. Thus no human interaction is required when a user boards or disembarks a vehicle; instead the transport system tracks automatically the movement of the user through communication with the user device.

As explained later, the user device may be a multi-purpose device, such as a mobile telephone for example, or may be a dedicated device. The dedicated device is preferably valid for a number of trips, or for a specified time such as a month. The user device is preferably not pre-configured for a specified trip when obtained by the user, but instead is flexible to allow the user to use the user device to obtain transport services.

The term mass transit resource is intended to refer, for example, to vehicles which are designed to carry a large number of people, such as a bus or a tram. Typically such vehicles are scheduled to run over predetermined routes. Generally such vehicles are openly accessible to the public, albeit sometimes pre-booking is required. This term is not intended to cover vehicles, such as taxis, which although publicly available are intended to carry a relatively small number of people and tend to be privately arranged over a specific route selected by the user. As an exception however, small vehicles such as taxis that are used as secondary, short-haul transit vehicles to supplement the services of the main transit vehicles, are included

The step of optimizing the planned route may be carried out in response to one or more of the following: the rate of progress of, or the position of, the user along the planned route; the progress or availability of transit resources; traffic conditions; notified change in user destination or other requirements. Thus the optimum route and use of resources is ensured in real-time, taking into consideration changes in the operating conditions.

Preferably, the method also includes the step of determining whether information relating to the planned route is to be updated and, if necessary, providing updated information to the user. In this way, the user is kept informed of changes to the planned route.

The step of determining whether information relating to the planned route is to be updated may depend on one or more of: the rate of progress of, or the position of, the user along the planned route; the progress of one or more transit resources along their predetermined routes; the traffic or other conditions; the optimization of the trip plan. This is preferably determined in real-time, so that the optimum route and use of resources is ensured in real-time, taking into consideration changes in the operating conditions.

Preferably, the method also comprises the step of providing instructions relating to the planned route for the user to at least one of the transit resources. In this way the optimum route can be provided to the user whilst maintaining operational efficiency of the transport system.

Advantageously the method also comprises the step of determining whether instructions relating to the planned route for the user for any transit resource are to be provided or updated and, if necessary, providing initial or updated instructions to at least one of the transit resources. The providing or updating of instructions to the transit resources preferably occurs in real-time.

The step of determining whether instructions relating to the planned route for the user for any transit resource are to be provided or updated may depend on one or more of: the progress of the user along the planned route; the progress of one or more transit resources along their predetermined routes; the traffic or other conditions; the optimization of the trip plan. Thus the optimum route and use of resources may be ensured in real-time, taking into consideration changes in the operating conditions.

The method may also comprise the step of receiving from a user a request for transportation services from a location to a destination in response to which the planned route is determined.

The method may also include a further step of determining that the initial location and/or the final destination of the user is not proximate a predetermined route of any of the plurality of mass transit resources and providing instructions to an additional transport resource to transport the user from the initial location to a location proximate a mass transit resource route and/or providing instructions to an additional transport resource to transport the user from a destination proximate a mass transit resource route to the final destination of the user. In this way, a true door-to-door service may be provided.

The progress of the user along the planned route may be tracked by creating a trip record from received information relating to the user's progress along the planned route. The trip record may be used for billing the user. Preferably, the method further comprises the step of maintaining information relating to vehicle positions or timing.

Preferably, the control means for the mass transport system also comprises a user communication interface means coupled with the route planner means for communicating information between the user and the route planner means. The user communication interface means may be used to communicate one or more of the following information between the user and the route planner means: a request for transportation services from a location to a destination; current location of the user; initial information relating to the planned route; updated information relating to the planned route. The information may be exchanged between the user and the route planner means using one or more of a WAP connection; a wireless messaging service; a Bluetooth™ connection; a wireline connection; infra-red; RF-ID.

Advantageously, the control means for the mass transport system also comprises a transit resource communication interface means coupled with the route planner means for communicating information between the route planner means and the plurality of mass transit resources. The transit resource communication interface means may be used to communicate one or more of the following information between a mass transit resource and the route planner means: initial instructions relating to the planned route for the user; updated instructions relating to the planned route for the user; information relating to the progress of the user along the planned route. The information may be exchanged using one or more of a wireless connection; a Bluetooth™ connection; a wireline connection; infra-red; RF-ID.

The control means for the mass transport system may also comprise user information means coupled to the trip planner means for storing information relating to the planned route and information relating to the user's progress along the planned route.

The control means for the mass transport system may also comprise transit resource information means for storing information relating to position and timing of the plurality of the mass transit resources. Advantageously, the transit resource information means is coupled to the transit communications interface to receive information on progress of the mass transit resources therefrom.

In accordance with a third aspect of the present invention, there is provided a method of operation of a personal device adapted for operation in a mass transport system having a trip planner section and at least one mass transit resource, comprising sending a request for transportation services to the trip planner means; receiving from the trip planner means information relating to the planned route; and communicating with at least one of the trip planner means and the mass transit resource during execution of the planned route.

The invention also relates to a personal device adapted for operation in a mass transport system having a trip planner section and at least one mass transit resource, comprising means for sending a request for transportation services to the trip planner means; means for receiving from the trip planner means information relating to the planned route; and means adapted for communicating with at least one of the trip planner means and the mass transit resource during execution of the planned route.

Such a personal device preferably has one or more dedicated buttons eg for alerting the user of a connection.

Thus the user device in accordance with the invention is adapted to communicate with the trip planner means in particular to provide information to the trip planning means to enable automatic tracking of the user device by the trip planner means.

The user's personal device may be a Wireless Application Protocol (WAP) or other internet-enabled communication device, such as a mobile telephone or data terminal for example, preferably also having short-range communication capability (e.g. via Bluetooth™, infra-red, RF-ID or smartcard (contact-less or contact) applications). In this way the advantages of the mass transportation system in accordance with the invention can be enjoyed by a user with existing devices.

Alternatively and advantageously, it would be possible for the user's personal device to be a dedicated communication device either having only short-range communication capability (as outlined above) or having both short-range communication capability (as outlined above) and wireless communication capability via, for example a cellular communication system exemplified by, but not limited to, the Global System for Mobile communications (GSM) system, the Enhanced Data rates for GSM Evolution (EDGE) system or the Universal Mobile Telecommunications System (UMTS). The invention is particularly useful on packet data networks, such as General Packet Radio Service (GPRS) or UMTS. Preferably, such a dedicated communication device would also contain information identifying the user, for example for billing purposes.

A dedicated communication device would enable a mass transportation system operator to provide low cost device as the passenger's “ticket” for transportation, which would serve simultaneously for summoning transportation; payment; tracking; and providing system information. This is particularly advantageous where the dedicated communication device is issued to a regular user in place of a season or other multi-trip ticket but it is also envisaged that a dedicated device could also be used for single trips.

In accordance with a fourth aspect of the invention, there is provided a mass transit vehicle or terminal of a mass transport system for providing transportation for a plurality of users having a user device, the mass transit vehicle or terminal having means for communicating with a user device of a user on board the mass transit vehicle or near the terminal, and means for communicating information from the user device to a trip planner means of the mass transport system. The mass transit vehicle or terminal may also include means for receiving user information or instructions from the trip planner means and means for providing the user information or instructions to the user when the user device is near. The mass transit vehicle also preferably comprises means for receiving vehicle information or instructions relating to the planned route for at least one user.

For a better understanding of the present invention, and to show how it may be brought into effect, reference is made, by way of example, to the accompanying drawings, in which:

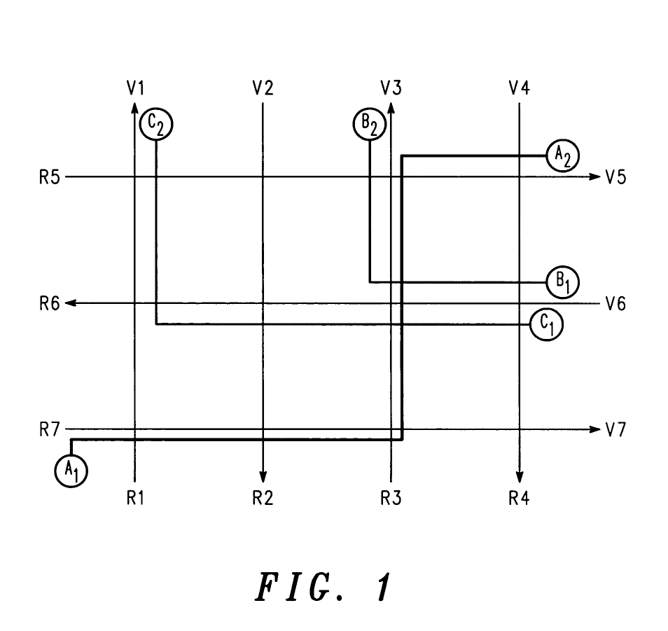

FIG. 1 shows an illustrative transport network in accordance with an embodiment of the invention;

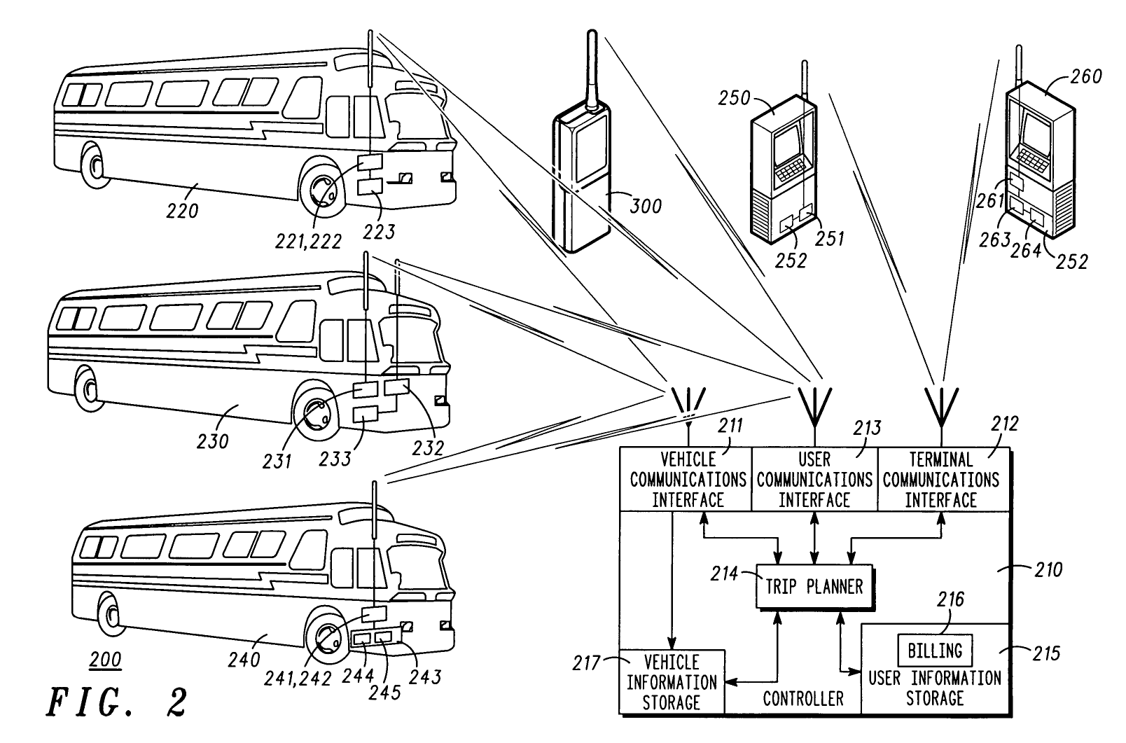

FIG. 2 shows a mass transportation system in accordance with an embodiment of the present invention;

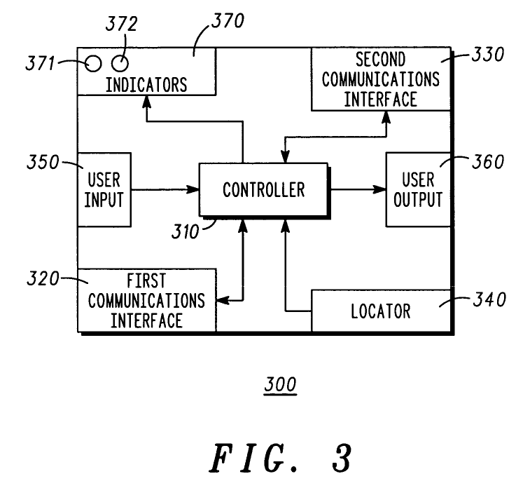

FIG. 3 shows an advantageous arrangement of a user device for use with a mass transportation system in accordance with the invention;

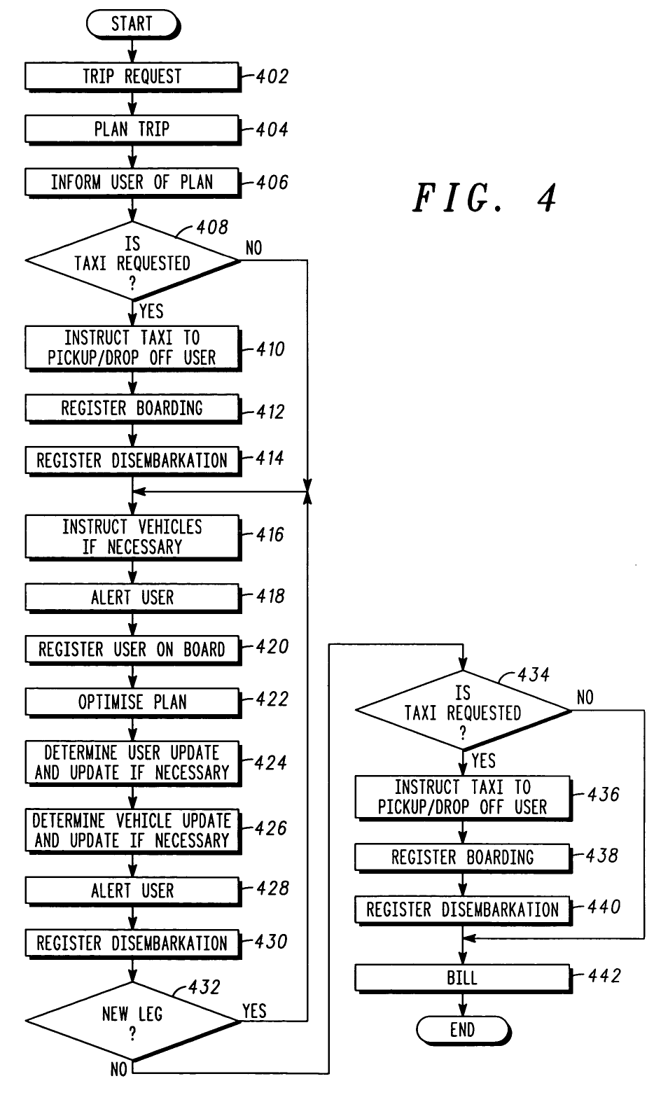

FIG. 4 is a flowchart of a method of operation in accordance with an embodiment of the invention

An exemplary embodiment of the present invention will now be described with reference to the accompanying drawings.

FIG. 1 shows an illustrative transport network 100 in accordance with an embodiment of the invention. The illustrated transport network 100 is a bus network, but it should be appreciated by a skilled person that the invention is also applicable to other forms of transport networks.

In the transport network 100 there are a plurality of mass transport vehicles, in this case a plurality of buses V1-V7. As indicated earlier, in the context of the invention mass transport vehicles are vehicles which are designed to carry a large number of people, such as a bus or a tram.

The plurality of buses V1-V7 travel along a respective plurality of predetermined routes R1-R7. In the illustrated network the predetermined routes R1-R7 are arranged in a grid format and none of the predetermined routes R1-R7 overlap: in real transport networks it is expected that at least some of the predetermined routes will overlap over at least part of their route.

In accordance with the invention, the movement of a user between a current location and a destination is planned and monitored by the transport system to ensure most efficient use of the transit resources and maximum convenience to the user.

User A at location A₁ wishing to travel to destination A₂ initially contacts the transport system with a travel request. The transport system plans the required route and informs the user of the planned route using buses V7, V3 and V5. The user boards bus V7 traveling along route R7 until the interchange with route R3. At the interchange, the user disembarks bus V7 and boards bus V3 to travel along route R3 until the interchange with route R5. At the interchange, the user disembarks bus V3 and boards bus V5 to travel along route R5 until reaching the destination A₂. The progress of the user along the planned route is tracked by the system, for example via notification of embarkation or disembarkation of the user.

At the same time User B at location B₁ wishing to travel to destination B₂ initially contacts the transport system with a travel request. The transport system plans the required route and informs the user of the planned route using buses V6 and V3. The user boards bus V6 traveling along route R6 until the interchange with route R3. At the interchange, the user disembarks bus V6 and boards bus V3 to travel along route R3 until reaching the destination B₂. The progress of the user along the planned route is tracked by the system, for example via notification of embarkation or disembarkation of the user.

User C at location C, wishing to travel to destination C₂ initially contacts the transport system with a travel request. The transport system plans the required route and informs the user of the planned route using buses V6 and V1. The user boards bus V6 traveling along route R6 until the interchange with route R1. At the interchange, the user disembarks bus V6 and boards bus V1 to travel along route R1 until reaching the destination C₂ The progress of the user along the planned route is tracked by the system, for example via notification of embarkation or disembarkation of the user.

Thus in general it can be seen that the different users use the vehicles at different points along the vehicle route, and that at some points the routes of the users overlap. However, the route followed by the users is planned and monitored by the transport system to ensure efficient use of the transit resources and enhance convenience to the user. If necessary the transport system may provide update instructions to the user and/or vehicles in response to the monitored progress of the user to maximize the efficiency of the system.

As will be explained in more detail hereafter, the interchange between the routes, for example between routes R7 and R3, may be a conventional bus stop but the use of a conventional bus stop as an interchange is not necessary and the interchange between the routes R7 and R3, for example, may be merely a point where the routes overlap.

Although not shown in FIG. 1, in one embodiment of the invention taxis or other non-mass transportation resources are used by the mass transport system operator to extend the operational area of the mass transport system.

In this embodiment a user at a location not on a vehicle route initially contacts the transport system with a travel request. The transport system plans the required route as above, but includes in the plan an initial leg by taxi or other such non-mass transportation resource from the initial location to a pick-up location on or near a vehicle route, and informs the user of the planned route as normal. Equally, if the user requests transportation to a destination not on a vehicle route, the transport system may include in the plan a final leg from a destination or drop off point on or near a vehicle route to the final destination by taxi or other such non-mass transportation resource.

A mass transportation system 200 in accordance with an embodiment of the present invention will now be described with reference to FIG. 2.

The exemplary mass transport system 200 comprises a control section 210, a plurality of vehicles exemplified by vehicles 220, 230, 240, and a plurality of terminals exemplified by terminals 250 and 260. The plurality of vehicles 220, 230 and 240 are mass transit vehicles following a predetermined route, as explained above in connection with the illustrative transport network 100 shown in FIG. 1. As will be apparent, the inclusion of terminals 250 and 260 in the mass transport system is not essential. An exemplary user's device 300 is also shown.

The control section 210 of the mass transportation system 200 has a vehicle communication interface 211, a terminal communication interface 212 and a user communication interface 213 for communicating with the vehicles 220, 230, 240, with the terminals 250 and 260, and with the user device 300 respectively.

The vehicle communication interface 211, terminal communication interface 212 and user communication interface 213 are shown as separate entities for clarity. However, a skilled person will appreciate that one or more of the communication interfaces 211, 212, 213 may be combined as a single communication interface.

Moreover, in FIG. 2 the vehicle communication interface 211, terminal communication interface 212 and user communication interface 213 are shown as forming a wireless link with the vehicles 220, 230, 240, with the terminals 250 and 260, and with the user device 300 respectively. These wireless communication links are preferably established using the GSM or future UMTS cellular networks, for example. However, the communication links may be established by means of wire-line communication links, either direct to a terminal, or to a terminal or other apparatus which can communicate with the vehicles or the user over a short-range communication method such as Bluetooth™, an infra-red link or RF-ID.

The control section 210 also has a trip planner section 214 interfaced with the communication interfaces 211, 212, 213; a user information storage system 215, preferably including a billing section 216, interfaced with the trip planner section 214; and a vehicle information storage system 217 also interfaced with the trip planner section 214 and with the vehicle communication interface 211. The trip planner section 214 may be implemented as a dedicated processor running suitable program instructions, or the trip planning function may be provided by the calling of a trip planning routine by a general purpose processor. The trip planner section 214 uses information from the user information storage system 215 and/or from the vehicle information storage system 217 to plan and/or update user information and/or vehicle instructions relating to a user's journey. The resulting information and instructions are sent to the user and/or the vehicle via the communication interfaces 211, 212, 213.

The user information storage system 215 stores information relating to each of a plurality of users, such as requested journey, planned route, progress of user along planned route or current location of the user. Preferably user information storage system 215 is implemented as a database. The billing section 216 is optional, or may be included as part of a separate system within the mass transportation system 200.

The vehicle information storage system 217 stores information relating to the plurality of vehicles, such as scheduled route, scheduled times, actual position or progress along scheduled route. Again, preferably the vehicle information storage system 217 is implemented as a database.

The vehicles 220, 230 and 240 are provided with vehicle system interfaces 221,231, 241 respectively, for establishing a communication link with the vehicle communication interface 211. In addition the vehicles are provided with a respective user system interface 222, 232, 242 for establishing a communication link with the user communication interface 213. Furthermore, the vehicles are provided with a respective user vehicle interface 223, 233, 243 coupled to the respective user system interface 222, 232, 242.

As can be seen from a comparison of vehicles 220 230 and 240, the vehicle system interface 221, 231, 241 may be implemented as a separate system from the corresponding user system interface 222, 232, 242 (vehicle 230) or alternatively the system interface 221,231, 241 and the corresponding user system interface 222, 232, 242 may be implemented as a single system (vehicles 220 and 240).

In vehicles 220 and 230 the user vehicle interface 223 and 243 is implemented as a short-range communication interface for communicating with the user's device 300 when within range of the user vehicle interface 223 and 243. This short-range communication interface may utilize Bluetooth™, an infra-red link RF-ID, contact- or contact-less smart card technology, for example. Thus information can be passed from the user device to the control section via the user vehicle interface and the user system or the vehicle system interface.

In vehicle 240 the user vehicle interface 243 is implemented as a user input device 244, such as a key pad, together with user output device 245, such as a display screen. This arrangement is useful where the user does not carry a “smart” device, such as user device 300, but instead interacts with the mass transport system only by devices provided for common use by the mass transport provider, such as the terminals 250, 260 and the user input device 244 and user output device 245 illustratively provided in vehicle 240. Of course, it would be possible for a vehicle to have for example both a Bluetooth™ interface and a keypad/screen to accommodate users with or without a “smart” device.

Terminals 250 and 260 are provided with a respective user system interface 251 and 261 for communicating with the terminal communication interface 212 of the central control section 210 and a respective user terminal interface 252 and 262 coupled to the respective user system interface 251 261.

In a similar manner to the user vehicle interfaces 223 and 243, the user terminal interface 252 is implemented as a short-range communication interface for communicating with the user's device 300 when within range of the user terminal interface 252. Again, this short-range communication interface may utilize Bluetooth™, an infra-red link, RF-ID, contact- or contact-less smart card technology, for example.

In terminal 260 the user terminal interface 262 is implemented as a user input device 263, such as a key pad, together with user output device 264, such as a display screen. Again, it would be possible for a terminal to have for example both a Bluetooth™ interface and a keypad/screen to accommodate users with or without a “smart” device.

Advantageous arrangements of the user device 300 will now be described with reference to FIG. 3.

An advantageous arrangement of a user device 300 for use with the mass transportation system of the present invention is shown in FIG. 3. User device 300 has a control section 310; a first communications interface 320, for example a short-range communications interface such as a Bluetooth™ interface; a second communications interface 330, for example a wireless communications interface; a location section 340, such as a GPS section; a user input section 350, such as keyboard and/or command buttons; a user output section 360, such as a screen; and an indicator section 370 containing a plurality of indicators 371, 372 etc, for example LEDs. The control section 310 is coupled to the other parts of the device as shown. As will be apparent to a skilled person, not all of these sections are necessary for some modes of operation of the mass transportation system in accordance with the invention. The user device 300 may be a mobile telephone or personal digital assistant or may be a specialized device.

The method of operation of the transportation system in accordance with an embodiment of the invention will now be described with reference to FIG. 4.

Initially, the user submits a request for transportation from a location to a destination, and this request is received by the central control section of the mass transportation system in step 402. A number of different ways in which the transportation request may be submitted are envisaged in accordance with the present invention.

In one arrangement, the user has a WAP-enabled user device and is able to access a map, for example downloaded from a website provided by the mass transportation system, to identify the current location and the required destination. Alternatively the user device may be GPS-enabled, enabling the user device to identify its current location to the mass transportation system. In addition it would also be possible for the user to send an SMS or other message to the mass transportation system. Advantageously, in each of the above methods the communication with the mass transportation system is established via the second communications interface 330 (FIG. 3) and the user communications interface 213 (FIG. 2) using for example a GPRS or UMTS network.

In an alternative arrangement, the request for transportation services may be conveyed to the mass transportation system via the first communications interface 320 of the user device 300 and the user terminal interface 252 of terminal 250 or via direct user interaction with the user terminal interface 262. The request for transportation services might also be submitted via a Bluetooth™ or other “hidden” interface provided at a bus stop, for example. Exceptionally, the request may be made which the user is on board a vehicle by means of the user vehicle interface 223, 233, 243. Such a request is then transmitted to the central control section 210 of the mass transportation system.

In an advantageous arrangement codes corresponding to particular journeys from which to choose are made available to the user. These codes may be personal pre-configured codes (for example “home” to “work”) stored in the user information storage system 215, for example, or may be general codes accessible to any user (for example “train station” to “town center shops”).

Once a request for transportation has been received in step 402, the trip planner section 214 plans the user's route between location and destination using information in the vehicle information storage system 217, for example relating to the routes of the vehicles in step 404. In addition information stored in the user information storage system 215, for example user preferences may also be used. Different algorithms may be utilized in planning the route, which will not be discussed further. Information relating to the specific planned trip is stored in the user information storage system 215.

Once the route plan has been calculated the trip planner section 214 informs the user of the plan in step 406, preferably via WAP or an SMS message direct to the user device or via a Bluetooth™ interface to the user device for users near terminals or vehicles. Alternatively screen 264 of a terminal 260 may be utilized for users without a user device.

As mentioned previously a true door-to-door service may be offered to users by the mass transportation service operator in an advantageous development of this application by integrating a taxi service pick-up from a user's initial location off the vehicle routes to a suitable point on the vehicle routes, either a conventional bus stop or any point on the vehicle routes. Thus, at step 408 the trip planning section 214 checks to see whether a taxi pick-up is necessary and instructs a taxi pick-up if necessary in step 410. Although it is not necessary, preferably trip planning section 214 is informed of the boarding of the taxi by the user and subsequent disembarkation of the user and this information relating to the progress of the user along the planned trip is registered in the user trip record in the user information storage system in steps 412 and 414.

In accordance with a preferred embodiment of the invention, in step 416 the trip planner section 214 sends instructions, if necessary, relating to the user's trip to at least one of the vehicles 230 via the vehicle communications interface 211 of the central control section 210 and the vehicle system interface 231 of the vehicle 230. These instructions may be for the vehicle 230 to pick up the user at a specified position along the vehicle's route which is not at a conventional bus stop, or may be for vehicle 230 to wait at a particular interchange point to pick up a user, for example.

Advantageously, in step 418 the trip planning section 214 sends an alert to the user prior to the pick up of the user by a vehicle 230. The trip planner section 214 preferably obtains updated vehicle location information from the vehicle information storage system 217 to determine when to send the alert to the user. The alert is sent by any suitable communication method between the user and the trip planning section, as discussed previously.

The boarding of the vehicle 230 by the user is detected by the user vehicle interface 233 interaction with the user device of the user and this information is passed to the central control section 210 via the system vehicle interface 231. This information from the user device relating to the progress of the user along the planned trip is registered in the user trip record in the user information storage system 215 in step 420.

Preferably, the trip planner section 214 reviews the planned route in step 422 to ensure that the planned route is still optimum, and if not makes any necessary amendments to the planned route. The planned route may no longer be optimum for a variety of reasons, for example in view of the progress of the user along the planned route i.e. unexpected delay or advance in the progress of the user, traffic conditions affecting the planned route may have altered, a vehicle planned for part of the route may be stuck in traffic or broken down, or the user may have notified the trip planner section 214 of a change in the requested destination.

Advantageously, in step 424 the trip planner section 214 determines whether the instructions or information provided to the user should be updated, and sends updated information or instructions to the user, if necessary. Advantageously, in step 426 the trip planner section 214 also determines whether the information or instructions provided to one or more of the vehicles should be updated, and sends updated information or instructions to one or more vehicles, if necessary. Instructions or information provided to the user or to the vehicles may be updated in view of, for example, any changes to the plan following optimization step 422; the progress of the user along the planned route; the progress of one or more vehicles; traffic or other conditions. Additional examples of providing instructions to one of the transit resources may be to wait a short while for a passenger who is just about to reach his next connection, or instructing a bus to stop at an unplanned stop in order to pick up a passenger or enable a connection so that the passenger can transfer from one vehicle to another.

Although steps 422, 424 and 426 are shown following boarding of a vehicle and registration of that information, it will be clear that these steps could be carried out at other stages, or in response to a request to alter the destination received from a user, for example.

Advantageously, in step 428 the trip planner section 214 sends an alert to the user to inform the user to disembark. The alert is sent by any suitable communication method between the user and the trip planner section 214, as discussed previously.

The disembarkation of the user is detected by interaction between the user device and the user vehicle interface 233, and this information is passed to the central control section 210 via the system vehicle interface 231. This new information from the user device relating to the progress of the user along the planned trip is registered in the user trip record in the user information storage system 215 in step 430.

Next the trip planner section 214 determines whether the planned route requires a further leg on a vehicle in step 432. If so, the method returns to step 416. If no further leg on a vehicle is required, in step 434 the trip planner section 214 determines whether a taxi is required for the final leg of the journey to the user's destination. If so, the trip planning section instructs the taxi and optionally registers the boarding of the taxi and subsequent disembarkation from the taxi in steps 436, 438 and 440 similar to steps 410, 412 and 414 described above.

The user may pay for the trip in the conventional way, by paying separately for each leg of the journey on the respective vehicle or taxi. However, advantageously the system in accordance with a preferred embodiment of the invention enables centralized billing for the entire trip using the billing section 216. Thus, advantageously in a billing step 442 carried out once the user's journey has been completed, the billing section 216 may calculate the charge for the trip using the record of the trip stored in the user information storage system 215. The billing may be carried out in a number of different ways, for example by requesting payment from an electronic wallet carried by the user (possibly in conjunction with the user device 300 outlined above), by debiting a credit balance held by the billing section 216 or by adding the trip to a monthly bill for transportation services.

In addition or alternatively, the cost or the expected cost for the requested trip may be provided to the user in response to the request for transportation service. In this way, a user could obtain competitive quotations for the trip, possibly also including an estimate of the time for the trip.

Thus, it can be seen that an extremely preferable method of providing mass transportation and a corresponding mass transportation system can be provided, in the preferred embodiment of which enables a user to carry a user device allowing access to the transport resources and enabling the system to track of the user automatically through interactions between the user device and the transport system instead of between the user and a human representative of the transport system provider. This system can optimize the route taken by the user and may enable route times close to those achievable with private transportation to be provided to users while making efficient use of the mass transit resources available to the transport system operator.

In advantageous arrangements of the invention users may be picked up or dropped off anywhere along the vehicle routes, not necessarily at scheduled stops as is conventional. Equally a user may change from one vehicle to another at arbitrary points where routes overlap, not necessarily at scheduled bus stops as is conventional. Moreover, a user may be provided with an enhanced door-to-door service in which a taxi or other small personalized transport resource is utilized to take the user from the initial location to a suitable point on a vehicle route and/or to take the user from a drop-off point on a vehicle route to the final destination.

The system enables the trip to be optimized despite any real-time change of plan by the user and to take account of changes in traffic or availability of allocated transport resources.

Mass transit is theoretically very efficient. However the efficiency of mass transportation is offset by lack of communication channels between carriers and customers, preventing full utilization of the service. The invention makes use of modern communications technology in order to help restore the lost efficiency almost back to the full theoretical capability. This is done by providing for real-time communications between the mass transport system provider and individual customers, and methods for using such channels. Thus, a mass transportation system of an unprecedented efficiency may be achieved, creating a breakthrough in the way we use transportation

As the invention may have a profound effect on the way the mass transport system is utilized, the provider of the mass transport system might choose to reorganize the system accordingly. For example, he might choose to modify the grid of fixed routes, change frequency of certain bus lines, etc. so as to seek optimum efficiency and effectiveness when assuming that many or most of the users are using this invention. The result would be a novel transportation system, based on this invention.

As will be apparent to a skilled person, the invention could be implemented in a different form from that shown herein, and so the invention is intended to encompass all arrangements and variations within the scope of the appended claims.

1. A method of route planning, in a mass transport system for providing transportation from a respective location to a respective destination for each of a plurality of users using a plurality of mass transit resources traveling along predetermined routes, wherein each of the users has a user device, the method comprising:
determining a planned route for a user from location to destination using at least one of the plurality of mass transit resources;
providing the user with information relating to the planned route; and receiving information communicated from the user device of the user so as to automatically track the progress of the user along the planned route; and
optimizing the planned route during progress of the user along the planned route.

2. The method as claimed in claim 1 wherein the step of optimizing the planned route may be carried out in response to one or more of the following: the rate of progress of, or the position of, the user along the planned route; the progress or availability of transit resources; traffic conditions; notified change in user destination or other requirements.

3. The method as claimed in claim 1 further including the steps of determining whether information relating to the planned route is to be updated and, if necessary, providing updated information to the user.

4. The method as claimed in claim 3 wherein the step of determining whether information relating to the planned route is to be updated may depend on one or more of: the rate of progress of, or the position of, the user along the planned route; the progress of one or more transit resources along their predetermined routes; the traffic or other conditions; the optimization of the trip plan.

5. The method as claimed in claim 1 further comprising the step of providing instructions relating to the planned route for the user to at least one of the transit resources.

6. The method as claimed in claim 1 further comprising the step of determining whether instructions relating to the planned route for the user for any transit resource are to be provided or updated and, if necessary, providing initial or updated instructions to at least one of the transit resources.

7. The method as claimed in claim 6 wherein the step of determining whether instructions relating to the planned route for the user for any transit resource are to be provided or updated may depend on one or more of: the rate of progress of, or position of, the user along the planned route; the progress of one or more transit resources along their predetermined routes; the traffic or other conditions; the optimization of the trip plan.

8. The method as claimed in claim 1 also comprising the step of receiving from a user a request for transportation services from a location to a destination in response to which the planned route is determined.

9. The method as claimed in claim 1 also comprising a further step of determining that the initial location and/or the final destination of the user is not proximate a predetermined route of any of the plurality of mass transit resources and providing instructions to an additional transport resource to transport the user from the initial location to a location proximate a mass transit resource route and/or providing instructions to an additional transport resource to transport the user from a destination proximate a mass transit resource route to the final destination of the user.

10. The method as claimed in claim 1 wherein the progress of the user along the planned route comprises is tracked by creating a trip record from received information relating to the user's progress along the planned route.

11. The method as claimed in claim 10 further comprising the step of determining the charge for the trip based on the trip record.

12. The method as claimed in claim 1 further comprising the step of maintaining information relating to mass transit resource positions or timing.

13. A control means, for a mass transport system for providing transportation from a respective location to a respective destination for each of a plurality of users using a plurality of mass transit resources traveling along predetermined routes, wherein each of the users has a user device, comprising a route planner means comprising:
means for determining a planned route for a user from location to destination using at least one of the plurality of mass transit resources;
means for providing the user with information relating to the planned route;
means for receiving information communicated from the user device of the user so as to automatically track the progress of the user along the planned route; and
means for optimizing the planned route during progress of the user along the planned route.

14. The control means for a mass transport system as claimed in claim 13 further comprising a user communication interface means coupled with the route planner means for communicating information between the user and the route planner means.

15. The control means for a mass transport system as claimed in claim 14 wherein the user communication interface means is used to communicate one or more of the following information between the user and the route planner means: a request for transportation services from a location to a destination; current location of the user; initial information relating to the planned route; updated information relating to the planned route.

16. The control means for a mass transport system as claimed in claim 14 wherein the information is exchanged between the user and the route planner means using one or more of a WAP connection; a wireless messaging service; a Bluetooth™ connection; a wireline connection; RF-ID.

17. The control means for a mass transport system as claimed in claim 13 also comprising a transit resource communication interface means coupled with the route planner means for communicating information between the route planner means and the plurality of mass transit resources.

18. The control means for a mass transport system as claimed in claim 17 wherein the transit resource communication interface means is used to communicate one or more of the following information between a mass transit resource and the route planner means: initial instructions relating to the planned route for the user; updated instructions relating to the planned route for the user; information relating to the progress of the user along the planned route.

19. The control means for a mass transport system as claimed in claim 17 wherein the information is exchanged between the route planner means and the plurality of mass transit resources using one or more of a wireless connection; a Bluetooth™ connection; a wireline connection; RF-ID.

20. The control means for a mass transport system as claimed in claim 13 also comprising user information means coupled to the trip planner means for storing information relating to the planned route and information relating to the user's progress along the planned route.

21. The control means for a mass transport system as claimed in claim 13 also comprising transit resource information means for storing information relating to position and timing of the plurality of mass transit resources.

22. The control means for a mass transport system as claimed in claim 13 wherein the transit resource information means is coupled to the transit communications interface to receive information on progress of the mass transit resources therefrom.

23. A method of operation of a personal device adapted for operation in a mass transport system having a trip planner section and at least one mass transit resource, comprising
sending a request for transportation services to the trip planner means;
receiving from the trip planner means information relating to the planned route; and
communicating with at least one of the trip planner means and the mass transit resource during execution of the planned route.

24. A personal device adapted for operation in a mass transport system having a trip planner section and at least one mass transit resource, comprising
means for sending a request for transportation services to the trip planner means;
means for receiving from the trip planner means information relating to the planned route; and
means adapted for communicating with at least one of the trip planner means and the mass transit resource during execution of the planned route.

25. A mass transit vehicle or terminal of a mass transport system for providing transportation for a plurality of users having a user device, the mass transit vehicle or terminal having means for communicating with a user device of a user on board the mass transit vehicle or near the terminal, and means for communicating information from the user device to a trip planner means of the mass transport system.

26. The mass transit vehicle or terminal as claimed in claim 25 also comprising means for receiving user information or instructions from the trip planner means and means for providing the user information or instructions to the user when the user device is near.

27. The mass transit vehicle as claimed in claim 26, further comprising means for receiving vehicle information or instructions relating to at least one user.
